(19) United States
(12) Patent Application Publication
(10) Pub. No.: US 2021/0188686 A1
(43) Pub. Date: Jun. 24, 2021

(54) GRAVITY BENDING OF GLASS IN THE PRESENCE OF A RADIATIVE COUNTER-SKELETON

(71) Applicant: SAINT-GOBAIN GLASS FRANCE, COURBEVOIE (FR)

(72) Inventors: Thierry OLIVIER, THOUROTTE (FR); Jérôme PELLETIER, GUIGNIERES (FR)

(21) Appl. No.: 16/755,047

(22) PCT Filed: Oct. 18, 2018
(86) PCT No.: PCT/FR2018/052597

§ 371 Date: Apr. 9, 2020

(30) Foreign Application Priority Data
Oct. 19, 2017 (FR) 1759859
Oct. 19, 2017 (FR) 1759862

(51) Int. Cl. C03B 23/025; C03B 23/03; C03B 40/00

(52) U.S. Cl. CPC C03B 23/0256; C03B 2225/02; C03B 40/005; C03B 23/03

(57) ABSTRACT

A device and a process for the gravity bending of a glass sheet or a stack of glass sheets, referred to as the glass, includes the gravity bending of the glass on a skeleton including a contact rail supporting the glass in the peripheral zone of the lower main face thereof, the contact rail including concave curvatures in each of the sides of the skeleton, a counter-skeleton including a metal bar being present during the bending at a distance d from the edge face or from the peripheral zone of the upper main face of the glass, the peripheral zone of a main face being the zone between the edge of the glass and a distance from the edge of the glass of 50 mm of the main face, d being within the range from 0.1 to 50 mm.

The invention relates to the gravity bending of glass on a skeleton. A counter-skeleton is positioned opposite the peripheral zone or the edge face of the glass which prevents the formation of corrugations at its edges. This works even in the absence of contact between the counter-skeleton and the glass.

The gravity bending of glass is well known and is in particular documented in EP 448 447, EP 0 705 798, EP 885 851. In U.S. Pat. No. 1,999,558, the glass is forced to bend by a support on the edge face.

The tendency of motor vehicle manufacturers is to increasingly reduce the thickness of the glass sheets intended to be assembled within a laminated glazing. A thin sheet tends to be combined with a thicker sheet. It has been observed that the gravity bending of a glass sheet having a thickness less than or equal to 2.1 mm produced, on a conventional skeleton, corrugation defects on the edges of the glass, more particularly in the middle of the various sides of the glass. The phenomenon responsible for the creation of creases at the periphery of the glazing during the peripheral supporting thereof is an instability phenomenon similar to buckling (or warping) of sheets of elastic material. In the same way as in the case of thin sheets of elastic material, the peripheral instability phenomenon observed in the forming of glass sheets is even greater when the glass is thin and when the temperature at the periphery of the glass is high.

If it is sought to counteract the formation of these corrugations by pressing on the upper face of the glass undergoing bending, this tends to produce marks on this face and also on the lower face, and even to hamper the bending since the glass is trapped between a lower tool and an upper tool like in a jaw, which curbs the sagging thereof. The “marks” correspond to light mechanical indentations created by the tools on the glass during the bending thereof. They are particularly annoying when they are located on the lower surface of the glass (convex face) after bending since they are then visible from the outside of the vehicle. The “marks” which are located on the upper face of the glass (concave face) after bending are in general more readily accepted since they are inside the vehicle once fitted thereto and these imperfections are therefore hidden from the view of an observer outside of the vehicle.

According to the invention, the bending of glass is achieved by means of a device for the gravity bending of a glass sheet or stack of glass sheets, referred to as the glass, comprising a skeleton comprising a contact rail for supporting the peripheral zone of the lower main face of the glass, said contact rail comprising concave curvatures in each of the sides of said skeleton, and a counter-skeleton comprising a metal bar, said counter-skeleton being configured so that its metal bar is present at a positive distance d from the peripheral zone of the upper main face of the glass or the edge face thereof. The fact that the distance d is positive and therefore not zero implies the absence of contact of the counter-skeleton with the glass at the location where the distance d is measured. The distance d can be measured in a (virtual) vertical plane perpendicular to the edge of the glass. The vertical plane in which the counter-skeleton does not touch the glass is also perpendicular to the outer edge of the skeleton since the latter is substantially parallel to the edge of the glass. The bar of the counter-skeleton is the element of the latter which is active for the bending and closest to the glass during the bending. There is no solid element between the glass and the bar of the counter-skeleton. The distances d and D to which the present application refers relate to the metal bar of the counter-skeleton.

In order to not touch the glass, the device according to the invention comprises a means (separate from the glass itself) for imposing a distance d between the glass and the bar of the counter-skeleton. The counter-skeleton does not touch the glass at least in the zone of the middle of at least one of its sides. It is not excluded that it touches at least one corner of the glass but this is neither necessary, nor preferred. If the glass is of thickness e, the means for imposing a distance d between the bar of the counter-skeleton and the glass is also a means (separate from the glass itself) for imposing a positive distance D between the bar of the counter-skeleton and the skeleton, D being equal to d+e, if d is between the counter-skeleton and the upper face of the glass, or to d+f if d is between the counter-skeleton and the edge face of the glass, f being the overhang of the glass outward from the skeleton. At a location for which the distance d is complied with, then the counter-skeleton does not touch the glass, and it does not touch the skeleton even if the glass is not placed on the skeleton. In the device according to the invention, the skeleton and the counter-skeleton therefore have the same positions relative to one another, whether the glass has been loaded on the skeleton or not. Thus, the device for gravity bending of glass (of thickness e) is also such that it comprises a skeleton comprising a contact rail for supporting the peripheral zone of the lower main face of the glass and a counter-skeleton comprising a metal bar, said counter-skeleton being configured in order to have at least one face oriented toward the upper face of the skeleton or toward the outer face of the skeleton, said at least one face of the counter-skeleton having no contact with the skeleton, even in the absence of glass.

The skeleton supports the lower main face of the glass in the peripheral zone thereof, i.e. the zone between the edge of the glass and a distance from the edge of the glass of 50 mm. The zone of the glass touching the contact rail of the skeleton is entirely included within this peripheral zone. The counter-skeleton is opposite the peripheral zone of the upper main face of the glass and/or opposite the edge face of the glass. Preferably, the metal bar of the counter-skeleton is above and substantially opposite the skeleton.

The metal bar of the counter-skeleton is made of a compact metal, that is to say metal with no porosity, it being understood that it may be for example a tube or a T-shaped profile. It is rigid. It is substantially parallel to the glass and the skeleton so as to be able to act on an entire portion or even the whole of the peripheral zone parallel to the edge of the glass. The preferred portions of action of the counter-skeleton are the zones of the middles of the sides of the glass.

Seen from above, the counter-skeleton may optionally not cover the glass and therefore not obstruct the loading of the glass on the skeleton, nor the unloading thereof. In this case, the counter-skeleton is generally positioned opposite the edge face of the glass next to the edge of the glass. The counter-skeleton may then optionally be connected to the skeleton by a fixed link passing by the outside of the glass. This fixed link is in this case the means for imposing a distance d between the glass and the counter-skeleton (and therefore also the bar of the counter-skeleton). Of course, this link is sized as a function of the dimensions of the glass and so that any face of the counter-skeleton oriented toward the glass does not touch the glass.

The counter-skeleton may be removable (synonym: retractable) relative to the skeleton and to the glass. This is in particular necessary if, seen from above, the counter-skeleton covers a portion of the glass.

The glass placed on the skeleton may be an individual sheet having a thickness less than or equal to 2.1 mm, or even having a thickness less than or equal to 1.2 mm. Generally, the thickness of an individual sheet is greater than or equal to 0.4 mm. The glass placed on the skeleton may also be a stack of glass sheets, in particular sheets for which the thicknesses have just been given. The stack may also comprise sheets of different thickness. This stack may comprise 2, 3 or 4 sheets. In particular it is possible, with the device according to the invention, to bend a stack comprising a sheet having a thickness within the range from 1.4 to 2.7 mm, generally in the range from 1.4 to 2.5 mm, and a sheet having a thickness within the range from 0.4 to 1.6 mm, in particular in the range from 0.4 to 1.2 mm, the thickest sheet preferably being underneath the thinnest sheet during the bending on the skeleton. The sheets bent together by the device according to the invention may be intended to be combined together in the same laminated glazing, but not necessarily. For simplification, the term “the glass” is used to denote an individual sheet or a stack of sheets.

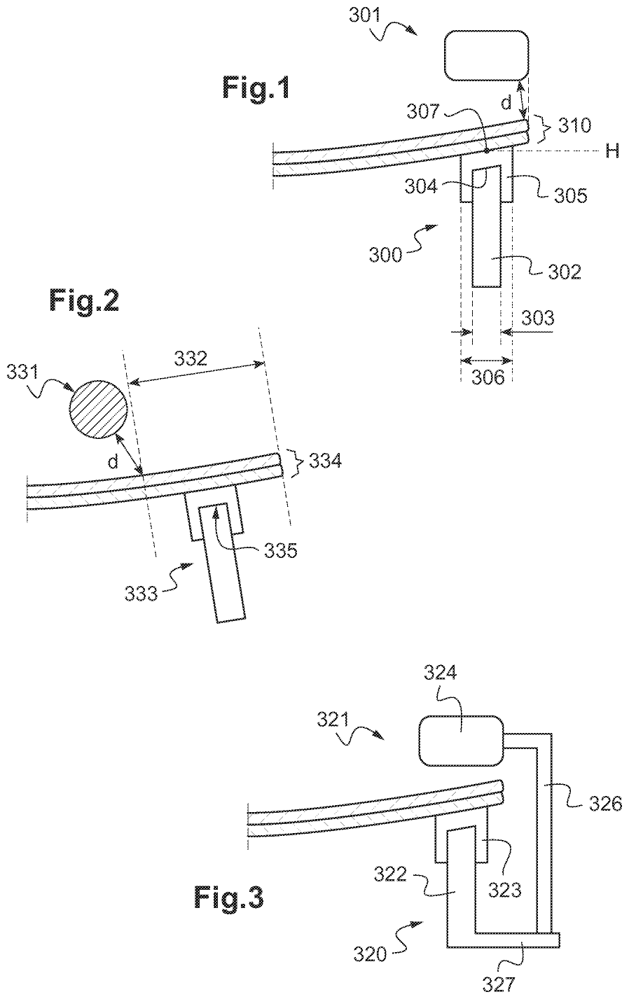

The skeleton comprises a metal strip (that may also be referred to as a “vertical plate”, even though the main faces thereof may optionally be inclined as represented in FIG. 2) having one of its edge faces upward in order to support the periphery of the glass. The skeleton also comprises, as coating on the upper edge face of its metal strip, a refractory fibrous material well known to those skilled in the art, forming the contact rail for the glass. The metal strip is rigid whereas the fibrous material has a certain elasticity and compressibility. This material of metallic and/or ceramic refractory fibers is generally of the felt or knitted fabric or woven fabric type, as is well known to those skilled in the art. These materials reduce the marking of the glass by the skeleton. The metal strip in the skeleton generally has a width within the range from 1 to 10 mm. The fibrous material generally has a thickness within the range from 0.3 to 1 mm. The skeleton offers the glass, via its refractory fibrous material, a contact rail having a width generally within the range from 1.6 to 12 mm (which includes the thickness due to the refractory fibrous material), more generally in the range from 3 mm to 10 mm. The skeleton has, on its face for contact with the glass, concave curvatures, this being for each of its sides and generally at least at the middle of each of its sides, the glass generally having four sides. The contact rail of the skeleton has concave curvatures for at least 80% and generally at least 90% of its length, said concavity being considered parallel to its (inner or outer) contours. The contact rail of the skeleton has concave curvatures for at least 80% and generally at least 90% of the length of its longitudinal sides, said concavity being considered parallel to its (inner or outer) contours. In particular, the contact rail of the skeleton has concave curvatures for the zone of the middle of its longitudinal sides, in particular for at least up to 20 cm on either side of this middle. The contact rail of the skeleton has concave curvatures for at least 80% and generally at least 90% of the length of its transverse sides, said concavity being considered parallel to its (inner or outer) contours. In particular, the contact rail of the skeleton has concave curvatures for the zone of the middle of its transverse sides, in particular for at least up to 20 cm on either side of this middle. The glass sags under the effect of gravity on the skeleton during the bending and adopts concave shapes seen from above (the concave face is the upper face) in its central zone and in each of its sides, in particular in the middle of its sides, the metal bar being at the distance d at least at the end of bending.

The skeleton has a shape that imparts this concavity, since at the end of bending, the glass touches the entire perimeter of the contact rail of the skeleton. At the end of bending, the glass being placed on the skeleton, the central zone of the upper face of the glass is concave in all directions. Seen from above, the skeleton has substantially the same shape as the glass that it must receive while being smaller since the glass extends over all sides of the skeleton. The contact rail of the skeleton therefore generally has a concave shape on each of its sides, in particular in the middle of its sides. The main faces of the glass comprise a plurality of sides, generally four sides, the skeleton has as many sides as the glass and therefore generally four sides (also referred to as “strips”). Before bending, the glass generally overhangs the entire perimeter of the skeleton by a distance within the range from 2 to 45 mm. This overhang reduces during the bending. This reduction depends on the size of the curvatures given to the main faces of the glass during the bending. At the end of bending, this overhang is generally within the range from 1 to 25 mm. From the start to the end of the bending, the skeleton generally supports the glass entirely in its peripheral zone and without going outside of this zone, neither outward, nor inward.

Seen from above, the skeleton has a continuous annular shape without interruption. Specifically, if the skeleton was segmented, this segmentation could produce a mark on the lower surface of the glass considering the fact that in the process according to the invention the glass sags essentially under the sole effect of its weight and it therefore quite readily follows the shape of its support and remains quite substantially at the differences in height/level of the skeleton.

The invention relates more particularly to the bending of glass for vehicle (motor vehicle, bus, truck, agricultural vehicle, etc.) glazing. It may be a windshield, rear window, or roof. The glazings considered here comprise a plurality of sides, generally four sides (also referred to as “strips”), a side joining another at a corner of the glazing, this corner comprising a curved segment comprising radii of curvature much smaller than those of the curvatures of the sides. The radii of curvature of the perimeter of the main faces are taken into consideration here viewed perpendicular to the main faces and to the edge of the glass. The middle of a side is at a substantially equal distance from its two corners. In the case of a windshield, rear window and roof, these glazings have a vertical plane of symmetry PS when they are mounted on the vehicle, the direction of movement of the vehicle (unturned steering wheel) being within this plane of symmetry. The sides that intersect this plane of symmetry are referred to as transverse sides, the two other sides being referred to as longitudinal sides. The middle of the sides is found in the following way: the curved glazing is placed on a horizontal plane, concave side downward. The glazing touches the horizontal plane via 4 points of contact at the corners of the glazing. The points of contact are connected together by line segments. The intersection with the edge of the glass of the plane perpendicular to the segment and passing through the middle of this segment, is the middle of the side of the glass. The middle of the transverse sides is also found at the intersection thereof with the vertical plane of symmetry PS.

A beneficial action of the presence of the counter-skeleton above the glass is observed, even in the absence of any contact with the glass. This phenomenon is attributed to a favorable thermal effect between the glass and the counter-skeleton. It is not necessary (even though this is not excluded) to provide the counter-skeleton with a refractory fibrous material coating its face oriented toward the glass. This thermal effect may, on the one hand, originate from the fact that the counter-skeleton shields the glass from thermal radiation coming directly from heating elements in the bending furnace and, on the other hand, from the fact that the counter-skeleton remains colder than the periphery of the glass during the rise in temperature and the bending. Specifically, due to the metal that it contains, the heat capacity of the counter-skeleton is greater than that of the glass. The counter-skeleton is therefore thermally more inert than the glass. Consequently, the presence of the counter-skeleton could slow down the temperature rise of the periphery of the glass during the temperature rise phase up to the bending temperature, producing a reduction in the temperature of the periphery of the glass, which would have a favorable effect on the peripheral instability phenomenon. In the vicinity of the softening temperature, the viscosity of the glass varies very greatly with the temperature and at around 620° C., a drop of 10° C. specifically corresponds to an increase in the viscosity by a factor of 2 approximately. A colder edge is more viscous and is therefore less sensitive to peripheral marking effects.

The invention relates to a process for the gravity bending of a glass sheet or a stack of glass sheets, referred to as the glass (which has a thickness e), comprising the gravity bending of the glass on a skeleton comprising a contact rail supporting the glass in the peripheral zone of the lower main face thereof, said contact rail comprising concave curvatures in each of the sides of said skeleton, a counter-skeleton comprising a metal bar being present during the bending at a distance d from the edge face or from the peripheral zone of the upper main face of the glass, the peripheral zone of a main face being the zone between the edge of the glass and a distance from the edge of the glass of 50 mm of said main face, d being within the range from 0.1 to 50 mm. The counter-skeleton may be present without interruption opposite the whole of the peripheral zone of the glass or the edge face thereof. In particular, it may be made of a single part. In particular, it may not touch the glass anywhere. However, the counter-skeleton may not be present opposite certain locations of the glass such as the corners of the glass. The counter-skeleton is preferably present opposite the zone of the middle of at least one side of the glass and even all the sides of the glass, the expression “opposite” relating to the peripheral zone of the upper face of the glass or the edge face thereof. Specifically, the problems of corrugation of the glass mainly take place in the zone of the middle of the sides and the counter-skeleton is therefore preferentially present opposite the zone of at least one middle of one of the sides of the glass, and even all the sides of the glass. The distance d is therefore complied with for the zone of the middle of at least one side of the glass, and preferably the zone of the middle of all its sides, the glass generally having four sides. The counter-skeleton may also be found opposite the corners of the glass, but this is not generally necessary.

The invention also relates to a process for the gravity bending of a glass sheet or a stack of glass sheets, referred to as the glass (which has a thickness e), comprising the gravity bending of the glass on a skeleton comprising a contact rail supporting the glass in the peripheral zone of the lower main face thereof, a counter-skeleton comprising a metal bar being present during the bending opposite the peripheral zone of the glass or the edge face thereof, and at a distance d, at the locations where corrugations appear in the absence of the counter-skeleton.

The distance between the counter-skeleton and the glass is not necessarily the same for the entire peripheral zone of the glass. As regards the zone of the middle of at least one side, it is preferably at least 0.1 mm in the whole of this zone, and this preferably being for all the sides of the glass. The zone of the middle of one side is the zone on either side of the middle in the peripheral zone of the glass. In particular, the zone of the middle of one side is the part of peripheral zone at least up to 5 cm on either side of the middle, and even at least up to 10 cm on either side of the middle, and even at least up to 20 cm on either side of the middle.

Thus, a (virtual) vertical plane, perpendicular to the edge of the glass, in which the condition regarding the distance d is satisfied preferably passes through the zone of the middle of at least one side of the glass, which is within the peripheral zone up to 20 cm (or even up to 10 cm, or even up to 5 cm) on either side of the middle of the side, parallel to the edge of the glass, and this preferably being for all the sides. Preferably, the condition regarding the distance d is satisfied for at least 50%, and preferably at least 80%, of the length of the zone of the middle of at least one side of the glass parallel to the edge of the glass, preferably without contact moreover of any tool with the edge face or the peripheral zone of the glass in the remainder of this zone of the middle of at least one side of the glass. Preferably, the condition regarding the distance d is satisfied for any vertical plane perpendicular to the edge of the glass and passing through the zone of the middle of at least one side of the glass (which implies in particular that the counter-skeleton (or any other tool) does not touch the glass in this zone of the middle), and this preferably being for all the sides of the glass, which are generally four in number.

Generally, the counter-skeleton does not touch the glass anywhere, and in particular neither the upper main face of the glass nor the edge face thereof. Therefore there is always an air space between the counter-skeleton and the glass during the bending. The distance d in a vertical plane perpendicular to the edge of the glass (and therefore also perpendicular to the skeleton since the latter is parallel to the edge of the glass) is the distance between the point of the counter-skeleton on the one hand and the point of the glass in the peripheral zone on the other hand that are closest. The counter-skeleton may optionally touch the glass at the start of bending considering that the glass is not yet bent but it does not touch the glass when the glass is in contact over the entire periphery thereof with the skeleton, in particular at the end of bending. Thus, the counter-skeleton (and therefore inevitably also its metal bar) preferably does not touch the glass when the glass comes into contact with the entire perimeter of the skeleton.

Preferably, d is at least 1 mm, preferably greater than 2 mm, in particular at least 5 mm. In particular, d may be at most 30 mm. Preferably, d is within the range from 1 mm to 50 mm and preferably within the range from 5 mm to 30 mm. These are distances d at the end of bending, when the glass touches the entire perimeter of the skeleton. The counter-skeleton may be at least partly over the side of the glass, or even not be above the glass, but opposite the edge face of the glass. The distance d values given above are preferably satisfied at least at the end of the bending, it being understood that the distance d may vary during the bending. The counter-skeleton, in particular its metal bar, is preferably at least partially above the level of the center of the glass-contacting rail of the skeleton. This center is the halfway point of the width of the contact rail of the skeleton in a vertical plane perpendicular to the skeleton (and therefore also to the glass). The centers form a central line all along the contact rail of the skeleton. When the counter-skeleton is at least partly above the glass, the counter skeleton is preferably at a distance from the edge of the glass that is less than or equal to 20 mm, at the end of bending.

The device according to the invention involves a means for imposing a non-zero distance between the glass and the counter-skeleton, and therefore also a space between the contact rail of the skeleton and the counter-skeleton. This means is used to prevent the counter-skeleton from touching the glass. It has been observed that the greater the mass of metal of the counter-skeleton opposite the glass, the further away the counter-skeleton could be from the glass while retaining the desired beneficial effect (no edge corrugation). This thermal effect can be increased by covering a portion of the counter-skeleton on at least one of its faces opposite to the glass and therefore also to the skeleton, with a thermally insulating material. This has the effect of slowing down the temperature rise of the counter-skeleton during the heating of the glass in preparation for the bending. Specifically, it has been observed that the counter-skeleton thus coated had an increased beneficial effect. At a distance from the glass at which an uncoated counter-skeleton no longer has an effect on the glass, the same counter-skeleton coated with a thermally insulating material again has a beneficial effect on the glass. The insulating material covering, if need be, the counter-skeleton is a material that conducts heat less well than the metal bar. It may be a fibrous material of metallic and/or ceramic refractory fibers.

The glass slides over the skeleton during the bending. The formation of the desired curvatures during the bending is not hampered due to a pinching between skeleton and counter-skeleton if the latter does not touch the glass. This is favorable for obtaining a shorter bending cycle time and this furthermore enables a more reproducible operation since it is not necessary to very finely adjust the space between the counter-skeleton and the glass.

The role of the counter-skeleton is not to bend the glass (this is the role of gravity), but just to prevent the formation of edge corrugations. Bending without the counter-skeleton would lead to an identical bending in the central zone of the glass compared to bending with a counter-skeleton, all other production conditions being identical. Although it is possible for the counter-skeleton to touch the glass at the start of bending, this is preferably no longer the case at the end of bending. In this way, at the end of bending and when the lower face of the glass touches the entire perimeter of the skeleton, the upper face of the glass is not in contact with any tool and is therefore only in contact with the ambient air. The final shape of the glass is therefore obtained in the last moments of the bending by the effect of gravity alone.

The curvatures of the glazings are characterized by the concepts of camber and cross-bending. For the definitions of these characteristics, reference may be made to FIGS. 1a and 1b and to the description corresponding thereto of WO 2010/136702.

The invention is very suitable for the bending of glass, the shape complexity of which is moderate, in particular the camber of which is less than 100 mm and the cross-bending of which is less than 20 mm (typically a windshield glass). The latter criteria are given by way of indication since the propensity for edge instabilities also depends on other criteria, either geometric criteria of the glass itself (such as the size of the glass or its peripheral cuts) or on parameters linked to the process (such as the thermal history of the glass during bending, of the temperature of its edges, or else of the initial temperature of the counter-skeleton during furnace charging), or on the composition of the counter-skeleton itself, in particular on the mass of metal incorporated, and whether or not it is coated on its face opposite the glass (and therefore also opposite the skeleton) with thermally insulating material. The device according to the invention is not very demanding in terms of geometrical tolerances. Specifically, the beneficial effect on the peripheral instabilities of the glass during the forming originate from radiative heat transfers that are moderately dependent on an imprecision of achieving the distance d. Therefore, this distance may generally be adjusted with tolerances of greater than 0.1 mm, in particular between 0.1 and 0.5 mm.

The shape of the counter-skeleton seen from above does not necessarily correspond exactly to that of the skeleton (and therefore of the glass). The counter-skeleton acts via a thermal effect and the important thing is that it contains a metal mass capable of procuring this effect and that it is in the vicinity of the periphery of the glass, especially in the vicinity of the zone of the middle of the sides of its main faces. This thermal effect is essentially dependent on three criteria: 1) the temperature of the counter-skeleton at the furnace entry which should be relatively moderate, preferably below 250° C., 2) the propensity of the counter-skeleton to remain colder than the periphery of the glass when the glass is between 300 and 650° C., and in particular during the bending, 3) the efficiency of the cooling of the edge of the glass by the counter-skeleton, which depends on the area of glass exposed to the counter-skeleton. Criterion 1 is ensured by a sufficient cooling of the counter-skeleton once bending is carried out. A portion of this cooling takes place in the bending furnace itself but also on the return line of the tools when they go back empty from the outlet of the furnace to the inlet of the furnace. Additional cooling systems specifically dedicated to the cooling of the counter-skeleton may be installed, such as additional fans or jets of air directed toward this tooling. It is also possible to provide a dedicated cooling circuit, directly fastened to the counter-skeleton, and which is activated on the return path of the tools, and more particularly of the counter-skeleton. It may in particular be a tube capable of receiving a stream of a coolant, in particular fresh air (i.e. generally at ambient temperature, generally between zero and 50° C.). Such a metal tube may be attached to the metal bar of the counter-skeleton. It may also be a counter-skeleton in which the metal bar comprises a metal tube of square or rectangular cross section in which fresh air circulates. Criterion 2 is ensured either by increasing the mass of metal integrated into that counter-skeleton, which has the effect of increasing its thermal inertia and therefore the amount of heat necessary for reheating it, or by limiting the heat input to the counter-skeleton by covering the latter with thermal insulation. Thus, the heating elements positioned in the crown of the furnace may heat the glass without actually needlessly wasting energy in directly reheating the counter-skeleton. The periphery of the glass is then even colder since it is on the one hand masked from the direct heat by the heating elements of the furnace (generally in the crown) and, on the other hand, since it is facing the counter-skeleton which is maintained at a reduced temperature. It should be noted that the cooling of a counter-skeleton coated with an insulating material is slower since the surface directly exposed to the free air on the return line of the tools is reduced. Criterion 3 is mainly ensured by the geometry of the counter-skeleton coupled to the distance between the counter-skeleton and the glass.

The general shape of the counter-skeleton is preferably complementary to that of the skeleton. The counter-skeleton then has convex curvatures in order to face the concave curvatures of the upper face of the glass. The counter-skeleton therefore generally has curvatures substantially parallel to those of the skeleton.

The means for imposing the distance d between the counter-skeleton and the glass (and therefore also a minimum space between the counter-skeleton and the skeleton) may in particular include an element that forms a stop, referred to as a stop, attached to the skeleton and on which an element that forms a counter-stop, referred to as a counter-stop, attached to the counter-skeleton, rests. The stop is fastened directly or indirectly to the rigid metal strip of the skeleton. It may be the upper surface of a plurality of jack stands or jack screws. The counter-stop is fastened directly or indirectly to the rigid metal bar of the counter-skeleton. If the counter-skeleton does not hinder the loading and unloading of the glass, the skeleton and the counter skeleton may be connected together in a fixed manner.

The device generally comprises a frame to which the skeleton is fastened. Any stop element may be fastened to the frame or to the skeleton, which still amounts to the fact that the stop is directly or indirectly attached to the skeleton. Advantageously, the means for imposing the distance d between the counter-skeleton and the glass (and therefore also between the counter-skeleton and the skeleton) is adjustable. The device according to the invention may therefore comprise a means for adjusting the distance d. The adjustment means may be located level with the stop and/or the counter-stop.

In the case of pronounced curvatures or complex shapes, in particular comprising pronounced curvatures in directions that are orthogonal to one another, it may be advantageous for the device according to the invention to comprise a system capable of modifying, during the bending, the distance between the skeleton and the counter-skeleton. Specifically, the counter-skeleton preferably has a shape closer to that of the upper face of the glass at the end of the bending, rather than at the start of the bending. Yet on laying the glass on the skeleton, the glass is flat or only slightly curved due to its natural flexibility. The counter-skeleton therefore has a more curved shape than the glass at the start of the bending and could touch it and, by elastic deformation, constrain it to adopt the peripheral shape of the skeleton. Such a situation risks leading to breakage of the glass at the furnace entry. This is why, without ruling out that the counter-skeleton can touch the glass from the start of the bending (from the furnace entry), it may be preferable for the counter-skeleton to be at first quite far away from the skeleton then to get closer thereto during the bending. Thus the space between the counter-skeleton and the glass (and therefore between the counter-skeleton and the skeleton) is progressively reduced as the glass softens and adopts the contours of the skeleton. The duration of the phase of bringing together the glass and the counter-skeleton may be adjusted between five tenths of a second to 30 seconds, or even up to one minute depending on the preceding thermal history and the complexity of the glazing itself.

Although the stresses applied to the glass at the furnace entry and during the bending are sufficiently moderate to avoid breakage of the glass, it is on the one hand quite possible for the counter-skeleton to be in partial contact with the glass, in particular at the middle or close to the middle of the top and bottom sides of the glass (in the mounted position on a motor vehicle) from the furnace loading and, on the other hand, it is possible to force the glass to bend due to the descent of the counter-skeleton. The counter-skeleton presses on the glass during its descent, which forces the peripheral bending. Such kinematics are advantageous since they make it possible to facilitate the main bending of the glass and thus to reduce the forming cycle time. Note that at the start of the process toward the entry of the furnace, the glass is at low temperature and less sensitive to marking and this is why, apart from the case of breakage, the quite emphatic contact of the counter-skeleton at this stage is not necessarily troublesome. The initiation of the bringing together of the glass and counter-skeleton may be relatively abrupt (simple initiation, i.e. passing in one go from a far-apart configuration to a close-together configuration) or else gradual. An initiation system may be actuated through the side walls of the furnace or else through the hearth of the furnace. An initiation system may in particular be similar to that described in U.S. Pat. No. 8,156,764. By way of example, the distance between the glass and the counter-skeleton in the zone of the middle of one side may be within the range from 0 to 30 mm at the start of bending, in order to finish in the range from 0.1 to 30 mm at the end of bending.

The glass is bent by gravity at a temperature within the range from 570 to 650° C., more generally in the range from 610 to 650° C. In order to achieve this bending, it is possible to convey the skeleton/counter-skeleton assembly loaded with glass through a tunnel furnace brought to the plastic deformation temperature of the glass. The device generally comprises a plurality of skeleton/counter-skeleton assemblies each loaded with glass and circulating one behind the other through the furnace. This furnace may be passed through by a plurality of such assemblies each loaded with glass and circulating one behind the other through the furnace. The furnace may comprise various temperature zones in order to gradually heat then gradually cool the glass. The skeleton and the counter-skeleton form an integrated assembly capable of being conveyed together horizontally but with no relative horizontal movement of one with respect to the other.

The glass is in contact with the skeleton for more than 10 minutes and generally more than 15 minutes and more generally between 15 and 30 minutes in the furnace while being conveyed through the furnace. The bar of the counter-skeleton is generally at a distance d from the glass and preferably at least partially above the glass, for more than 10 minutes in the furnace. The bending is carried out by gravity. In the absence of a counter-skeleton, during the bending, the glass would touch the whole of the skeleton, then, certain zones (in particular in the zone of the middle of at least one side of the peripheral zone) would lift up to leave contact with the skeleton. The counter-skeleton, by its radiative effect, serves to prevent this lifting up of the glass and guarantee total contact of the glass with the skeleton at the end of bending. The skeleton and the counter-skeleton form an integrated assembly capable of being conveyed through the furnace by a conveying means. The device may comprise means enabling the skeleton and the counter-skeleton to move closer together or further apart by a relative vertical movement with no relative horizontal movement of one with respect to the other, and this being even though the skeleton/counter-skeleton assembly is conveyed through the furnace. The term “relative” qualifying a movement signifies that this movement may be the work of the counter-skeleton alone or of the skeleton alone or of these two elements. The absence of relative horizontal movement of the skeleton and of the counter-skeleton with respect to one another means that these two elements remain opposite one another when seen from above during the horizontal movement of the skeleton/counter-skeleton assembly during the bending in the furnace. Thus, the device according to the invention generally comprises a furnace and a conveying means capable of horizontally moving the skeleton and the counter-skeleton together, referred to as a skeleton/counter-skeleton assembly, through the furnace and with no relative horizontal movement of one with respect to the other. It may comprise vertical translation means enabling the skeleton and the counter-skeleton to move closer together or further apart via a relative vertical movement during the horizontal movement thereof and with no relative horizontal movement of one with respect to the other.

After bending, the glass is cooled. For this cooling and in order not to create excessively large tensile edge stresses in the glass, the counter-skeleton is advantageously moved away from the glass. The separation of the counter-skeleton is advantageously carried out during the cooling of the glass and when the latter is at a temperature between 620 and 500° C. This separation may be achieved by various systems. It may be a “reset” system that carries out the reverse function of the “initiation” described above. Alternatively, the counter-skeleton may comprise or be composed of laterally retractable strips, generally four in number, like the glass since one side of the glass is associated with one retractable strip (see FIG. 10). The strips of the counter-skeleton move away at least laterally and where appropriate also vertically if necessary at the moment of the retraction so as to move away from the glass. The system that controls the retraction of the strips may be similar to one of those described in U.S. Pat. No. 8,156,764, i.e. for example through the side walls of the furnace or the hearth of the furnace.

The skeleton and the counter-skeleton are advantageously independent of one another, i.e. the counter-skeleton may then be entirely separate without having further connection with the skeleton. The glass may then be loaded on the skeleton then the counter-skeleton is put in place.

The loading of the glass on the device according to the invention may be carried out manually. The counter-skeleton being moved away if necessary, operators place the glass on the skeleton. Next, they place the counter-skeleton in its anticipated position. The position of the counter-skeleton is advantageously given by positioning columns (or any other means) fastened to the skeleton or to the frame. These positioning columns guide the counter-skeleton during the positioning thereof. This guiding is rendered possible for example by orifices in guiding lugs connected to the counter-skeleton and through which the positioning columns pass.

The loading and unloading of the glass may also be automated, in particular with the aid of robots, one for the loading, the other for the unloading. The use of robots makes it possible to have precise and reproducible movements and also a reliable and tolerant coupling system between the skeleton and its associated counter-skeleton. This system according to which the counter-skeleton can be completely separated from the skeleton makes it possible 1) to have a minimum amount of functions integrated into the tooling and thus to minimize the weight of the latter, which is a significant factor in energy consumption, 2) to minimize the risk of mechanical seizing and 3) to minimize the expensive maintenance operations on the forming tools. These advantages make this system more advantageous than the one described below (integration of the counter-skeleton on the skeleton).

Alternatively, the counter-skeleton may be part of a system directly integrated onto the skeleton itself and capable of retracting the counter-skeleton. In order to do this, by way of example, the counter-skeleton may be composed of four separate strips attached to the skeleton and which are retractable. They may move away from or join up with one another by movements that have both a horizontal component and where appropriate a vertical component that make it possible to move away from the glass, without sliding on this glass, while moving laterally away from the skeleton. Such a movement can be carried out by a simple rotation, the axis of which is judiciously chosen, in particular outside of the skeleton. When these strips move away the skeleton becomes accessible for an unloading or loading of glass.

If the counter-skeleton is of excessively light composition, its stiffness may be too low and its shape may change slightly during its use, following thermal stresses undergone during the heating and cooling cycles. In this case, it may possibly be observed that the space between skeleton and counter-skeleton is no longer uniform and no longer as it had been set initially. Thus, in the bending circumstances, a simple space adjustment by a system located only at the corners of the device, in particular by four jack screws, may prove insufficient. This is why, in particular if the counter-skeleton is very close to the glass, advantageously, a rigid structural element is positioned above the metal bar, the structural element and the metal bar being connected together by a plurality of spacers preferably that can be adjusted in terms of length that make it possible to locally adjust the distance between the structural element and the metal bar. The structural element is rigid so that it is considered to be undeformable despite the multiple thermal heating and cooling cycles undergone in order to bend glass sheets industrially. It may be used as a reference for adjusting the shape of the metal bar. The structural element advantageously comprises a metal profile, in particular metal tube, in particular of frame type. This tube may in particular have a square or rectangular cross section. It may comprise lateral extensions in order to be above the adjustment zones, the upper end of the spacers being connected to the extensions. The upper end of the spacers may also be directly connected to the structural element.

Thus, the device according to the invention may comprise a structural element at a level higher than that of the metal bar of the counter-skeleton, the structural element and the metal bar being connected by a plurality of adjustable spacers that make it possible to adjust locally the distance between the structural element and the metal bar, and locally the metal bar/glass distance and therefore also the metal bar/skeleton distance. The plurality of spacers is regularly distributed over the entire perimeter of the counter-skeleton.

The device is configured in order to carry out the process according to the invention.

The figures described below are not to scale.

FIG. 1 represents, in cross section and in a vertical plane perpendicular to the edge of the glass and of the skeleton, a device according to the invention comprising a skeleton 300 and a counter-skeleton 301. A stack of two glass sheets 310 rests via its periphery on the skeleton. The two tools each have an annular shape, the central zone of which is located to the left of their representation in the figure. The skeleton 300 comprises a metal strip 302 of width 303, the upper edge face 304 of which is covered with a refractory fibrous material 305 forming a contact rail of width 306 for the glass 310. The counter-skeleton comprises a metal bar 301 placed above the glass and having no contact therewith. The distance d between the metal bar of the counter-skeleton and the glass is within the range from 0.1 to 50 mm. This distance is that between the closest points of the counter-skeleton and of the glass. The metal bar of the counter-skeleton is above the level (horizontal line H in the figure) of the center 307 (at mid-width) of the glass-contacting rail of the skeleton.

FIG. 2 represents, in cross section and in a vertical plane perpendicular to the edge of the glass and of the skeleton, a device according to the invention comprising a skeleton 333, one edge face 335 of which is oriented upward, and a counter-skeleton 331. The counter-skeleton is located relatively inwardly with respect to the glass, but it is at a distance d of less than 50 mm from the peripheral zone 332 of the upper face of the glass 334.

FIG. 3 represents, in cross section and in a vertical plane perpendicular to the edge of the glass and of the skeleton, a device according to the invention comprising a skeleton 320 and a counter-skeleton 321. A stop 327 is fastened to the metal strip 322 of the skeleton. The edge face of this metal strip oriented upward is covered with a refractory fibrous material 323. The counter-skeleton comprises a metal bar 324 not coated with fibrous material, and that does not come into contact with the glass. A counter-stop 326 is connected to the metal bar 324 and may rest on the stop 327, blocking the progression of the counter-skeleton toward the skeleton and preventing contact of the counter-skeleton with the glass.

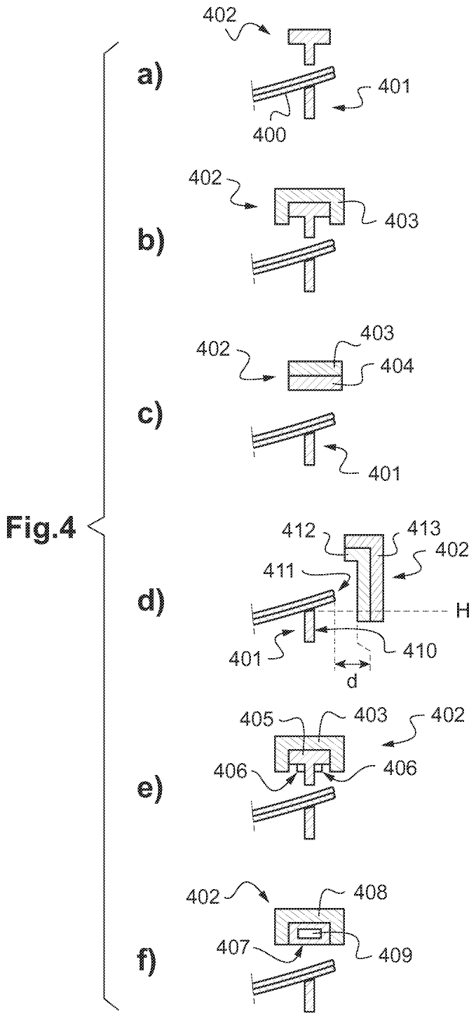

FIG. 4 represents various possible configurations of a device according to the invention comprising a skeleton 401 and a radiative counter-skeleton 402, i.e. that has no contact with the glass 400 (here a stack of two glass sheets), but that stabilizes the periphery of the glass during the bending. This view is taken in a vertical plane perpendicular to the edge of the glass and of the skeleton. The following variants are distinguished:
a) The counter-skeleton is a T-shaped metal bar, the vertical plate of the T is aligned with the strip of the skeleton. The horizontal bar helps to form a shield between the resistors of the furnace and the periphery of the glass.
b) The T-shaped counter-skeleton 402 from a) is covered on the upper portion thereof with an insulating material 403 which slows down the warming of the metal bar of the counter-skeleton.
c) The counter-skeleton 402 comprises a bar 404 of horizontal strip type forming a shield between the heating resistors and the glass, said bar being covered with an insulating material 403.
d) The counter-skeleton is L-shaped and is opposite the edge face 411 of the glass and opposite the outer face 410 of the skeleton. The counter-skeleton 402 is neither above the skeleton nor above the glass. However, most of the metal bar 412 of the counter-skeleton is above the level H of the central line of the contact rail of the skeleton. Owing to this shape and arrangement, the counter-skeleton forms an effective shield for the glass against the radiation of the furnace resistors coming from lateral directions. An insulating material 413 covers the faces of the counter-skeleton on the opposite side to the glass. This arrangement of the counter-skeleton frees up the space above the glass, which is advantageous for the loading and unloading of the glass.
e) The counter-skeleton comprises a T-shaped metal bar 405, the upper portion of which is covered with an insulating material 403. Metal tubes 406 through which a coolant travels make it possible to cool the counter-skeleton.
f) The counter-skeleton comprises a metal bar 407 of tube type with a rectangular cross section. This bar is hollow, and a coolant may travel through the interior 409 thereof in order to cool it. Its upper portion is covered with an insulating material 408.

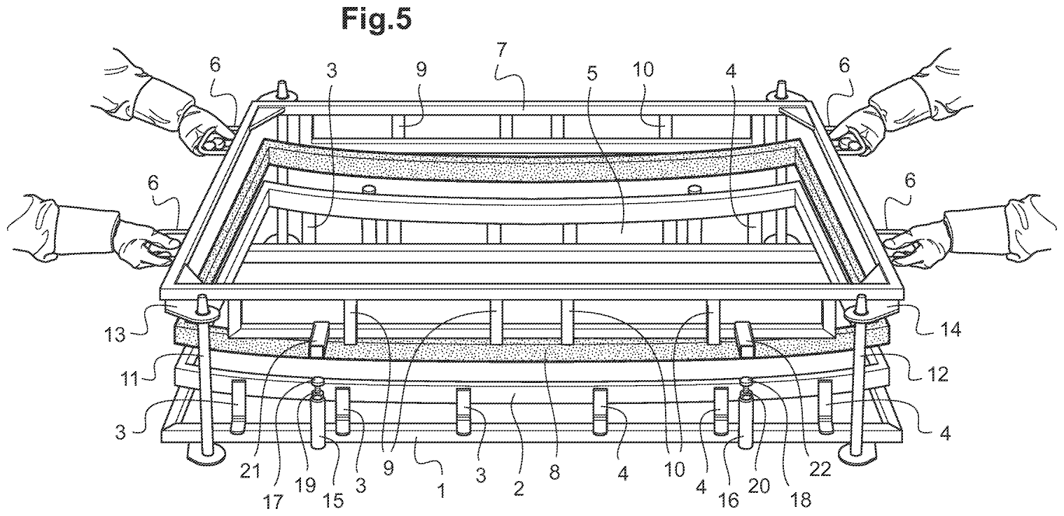

FIG. 5 represents a device according to the invention at the moment when a counter-skeleton 8 (shaded in the figure) is in the process of being positioned above the glass, the latter not being represented in the figure for the sake of clarity. A frame 1 is seen to which the skeleton 2 is fastened by means of lugs 3 and 4. The glass (not represented) is placed on the skeleton 2. Operators hold the counter-skeleton 8 by handles 6. These handles are fastened to a frame 7 to which the counter-skeleton 8 is fastened by means of lugs 9 and 10. The exact positioning of the counter-skeleton is ensured by guiding by means of four positioning columns (11 and 12 in the foreground), one at each corner. These columns are attached to the frame 1. Lugs 13 and 14 fastened to the frame 7 of the counter-skeleton that each comprise an orifice are slipped onto the columns 11 and 12 via their orifices. Jack stands 15 and 16 are part of the means for imposing a non-zero distance d between the glass and the counter-skeleton. They are each provided with bearing surfaces 17 and 18 that are height-adjustable by means of screws 19 and 20. The frame 7 connected to the counter-skeleton comprises lugs 21 and 22 that will rest on the bearing surfaces 17 and 18 when the operators have finished depositing the counter-skeleton. The weight of the counter-skeleton therefore rests on the bearing surfaces 17 and 18, the height of these being adjusted so that the spacing between the counter-skeleton and the glass is the chosen spacing. The bearing surfaces 17 and 18 form stops attached to the skeleton and the lugs 21 and 22 are counter-stops attached to the counter-skeleton. In this example, the counter-skeleton is present without interruption opposite the whole of the peripheral zone of the glass. It is made of a single part and, once positioned, does not touch the glass anywhere at least at the end of bending. The skeleton and the counter-skeleton here form an integrated assembly able to be moved horizontally through a furnace. The four positioning columns (11 and 12 in the foreground) are part of the means for vertical translation enabling the skeleton and the counter-skeleton to move closer together or further apart via a relative vertical movement and with no relative horizontal movement of one with respect to the other. In this way, the skeleton and the counter-skeleton remain opposite one another (on either side of the glass) during the horizontal movement of the skeleton/counter-skeleton assembly through the furnace.

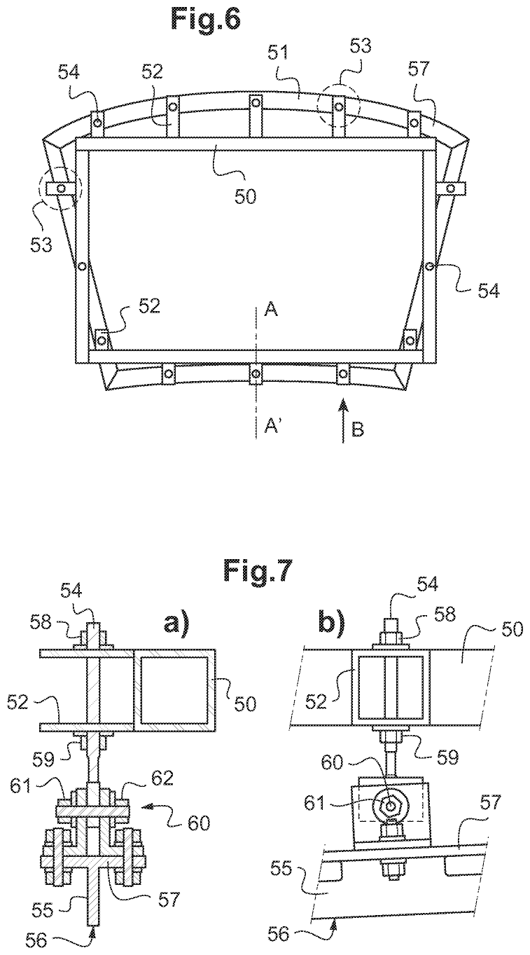

FIG. 6 represents, in top view, a rigid structural element 50 above a portion 51 of the counter-skeleton comprising a vertical plate (not visible) that is just above the glass and that acts as a metal bar. The visible portion 51 is a horizontal plate 57 that is just above the vertical plate and to which it is connected. The structural element 50 is made of a metal square and has the shape of a rectangular frame in top view. It comprises a plurality of extensions 52 connected to its inner or outer vertical faces, said extensions being, in top view, above zones 53 for adjusting the distance d with the glass. These adjustments are carried out by jack screws 54 here passing through the rigid structural element 50.

FIG. 7 shows the counter-skeleton from FIG. 6 along the cross section AA′ in a) and the side view along the direction B in b). The metal square of the rigid structural element 50 is seen again, an extension 52 being welded to an outer vertical face of said square. This extension is also made of a metal square. The vertical plate 55 (metal bar) is indirectly connected to the rigid structural element 50 so that it is attached thereto. The lower edge 56 of this vertical plate 55 is just above the glass and it is its distance d from the glass that should be adjusted. This adjustment is carried out by the jack screw 54 by screwing or unscrewing nuts 58 and 59. The vertical plate 55 is welded via its upper edge to a horizontal plate 57, in order to stabilize the position of the plate 55. The horizontal plate 57 is connected to the lower end of the jack screw 54 by means of a pivot connection 60, the pivoting of which is adjustable and can be locked in a given position by means of the nuts 61 and 62. The adjustment of this pivoting makes it possible to adjust the local inclination of the edge 56 so that this is indeed parallel to the skeleton and so that the distance between the counter-skeleton and the glass is indeed constant for the entire periphery of the glass.

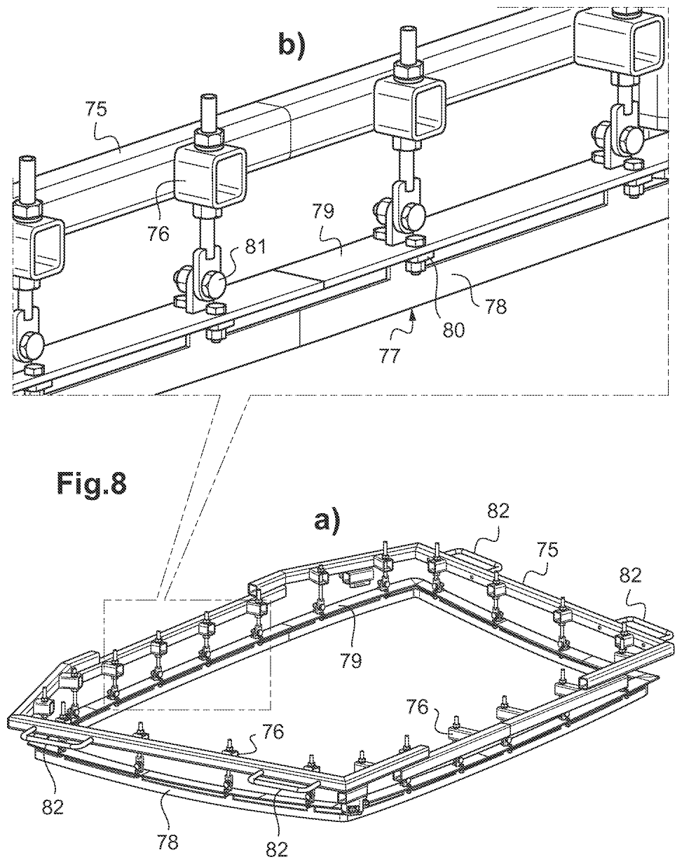

FIG. 8 represents a counter-skeleton according to the invention seen entirely in a), one portion being enlarged in b). A structural element 75 is produced from segments of metal squares welded together. Seen from above, this structural element has a shape similar to that of the skeleton and therefore of the glass to be bent. Lateral extensions 76 have been welded to inner vertical faces of the structural element. Jack screws for adjusting the gap pass vertically through these extensions. The adjustment of a jack screw makes it possible to locally adjust the height level of the lower edge 77 of a vertical plate 78 acting as metal bar. This vertical plate is attached to a horizontal plate 79 by a system of angle brackets 80 and screws and nuts. A pivot connection 81 above the horizontal plate 79 makes it possible to adjust the local inclination of the horizontal plate 79 for the purpose of adjusting the height level of the edge 77. Handles 82 are also seen enabling operators to handle this counter-skeleton and to place it above the glass. The correct lateral positioning of the counter-skeleton is ensured owing to focusing means which are not represented and which may be of the type of the jack stands 11 from FIG. 5.

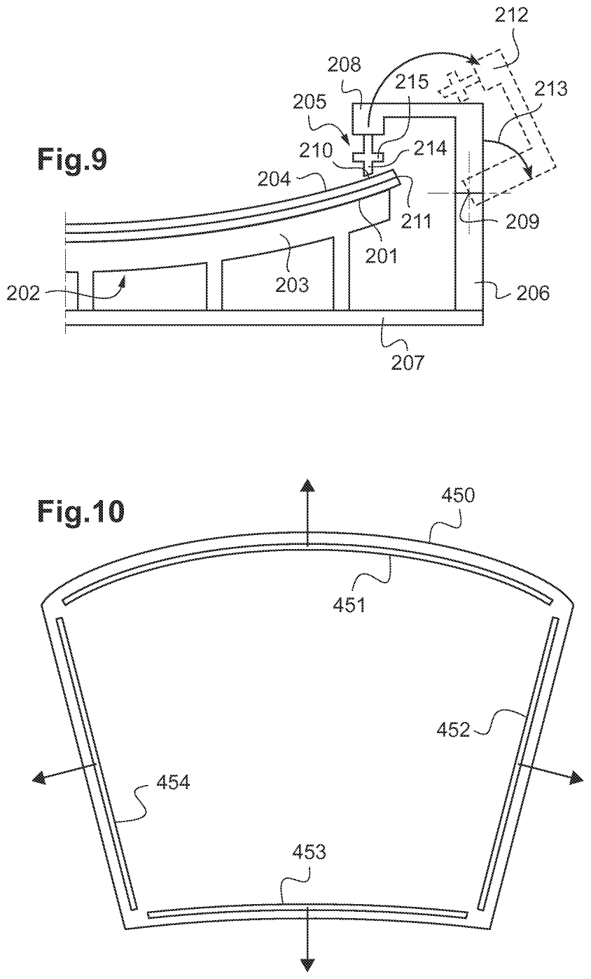

FIG. 9 represents, in cross section, a schematic view of a counter-skeleton 205 comprising laterally retractable strips. For simplification, a single side of the counter-skeleton has been represented, seen in the direction of its length. The glass rests via its lower main face 201 on the skeleton 202, which comprises a metal strip 203, one edge face of which is oriented upward. The counter-skeleton comprises as metal bar a vertical plate 214 and a horizontal plate 215. The skeleton and counter-skeleton are both provided with a refractory fibrous material (not represented) in order to come into contact with the glass. The counter-skeleton 205 is attached to an inverted U-shaped structure 208. The latter is connected to a base 206 itself attached to the structure 207 of the skeleton 202 via a pivot connection having a substantially horizontal axis 209. During the bending, the counter-skeleton is kept above the upper main surface of the glass 210, without touching it at least at the end of bending. The pivot connection makes it possible to retract the “counter-skeleton+U-shaped structure” assembly once the bending of the glass has been carried out, which makes it possible to easily remove the bent glass. The “counter-skeleton+U-shaped structure” assembly is represented in the retracted position by dotted lines 212. The position of the axis of rotation 209 of the structure of the counter-skeleton, is both quite high and far away from the edge of the glass 211, which enables the counter-skeleton to move away from the glass via a rotational movement (arrow 213) driving it both upward and also laterally. The retraction system is achieved by an initiation system, not described here but that may for example pass through the lateral walls of the furnace or else the hearth of the furnace. The retraction carried out during cooling makes it possible to obtain good edge stresses of the glass. Furthermore, the retraction also makes it possible to remove the glass from the skeleton by a conventional batten system pushing from underneath, and to easily load it at the furnace entry, with the aid of a robot for example. The counter-skeleton is again put in place by a reverse rotational movement once the next glass is loaded on the skeleton. It is seen that the contact rail of the skeleton is indeed concave over the entire length of the side visible in the figure, parallel to its inner and outer contours, this concavity being in the plane of the figure.

FIG. 10 represents a motor vehicle glazing 450, in top view, over its concave main face, surmounted by retractable strips (451, 452, 453, 454) of the counter-skeleton as explained for FIG. 9. These retractable strips are above the border of the glass and may be retracted laterally outward from the glass (according to the arrows) as explained for FIG. 9, so as to no longer be above the upper face of the glass.

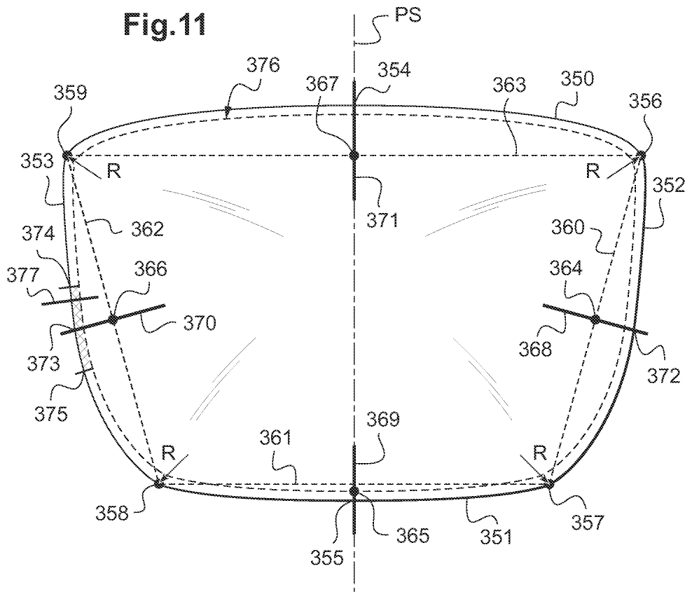

FIG. 11 represents a motor vehicle glazing of the windshield type, seen from above, and laid on a horizontal plane, concave face turned downward. It comprises four sides, two transverse sides 350 and 351 and two longitudinal sides 352 and 353. One side joins another side via a corner, the edge of which has radii of curvature R (viewed perpendicular to the surface of the glass and in each corner) that are very low relative to the radii of curvature of the edges toward the middles of the sides. This glazing is symmetrical with respect to the vertical plane of symmetry PS. This plane PS passes through the middles 354 and 355 of the transverse sides. This glazing rests on four points 356, 357, 358, 359 that are in the corners. The segments 360, 361, 362 and 363 connecting these four points have been drawn as dotted lines. These are the segments closest to the edges. One segment is associated with one edge. Each of these segments has a middle 364, 365, 366, 367. For each segment, there is a plane (368, 369, 370, 371) perpendicular to the segment and passing through the middle thereof. Each of these planes intersects with its associated edge at a point 372, 355, 373, 354 which is the middle thereof. The glazing is concave (in this figure, the concave face is turned downward) at least at the middle points of the edges 372, 355, 373, 354 and in all the hatched zones on either side of these middle points, said concavity being considered parallel to the outer edge of the glazing. The same is true for the skeleton that has supported this glass and for the zones of the skeleton corresponding to the zones of the middles of the sides of the glass, said concavity being considered parallel to the (inner or outer) contours of the skeleton and seen from above during bending. The dotted line 376 is 50 mm from the edge of the glass and forms the limit of the peripheral zone, which is between the edge of the glass and this line. The zone of the middle of the side 353 of the peripheral zone of the upper main face of the glass is the hatched zone on the left. This zone surrounds the middle point 373. The hatched zone is within the peripheral zone between the points 374 and 375 on the edge. Between these points 374 and 375, there is a vertical plane 377 perpendicular to the edge of the glass in which the condition regarding the distance d is satisfied. The points 374 and 375 are each 20 cm, or even 10 cm, or even 5 cm away from the point 373. The counter-skeleton is opposite this zone (above the glass or facing the edge face thereof) at least in this zone and if necessary continuously above the entire length of this zone parallel to the edge of the glass, i.e. with no discontinuity between the points 374 and 375, but not necessarily over the entire width of this zone.

1. A process for the gravity bending of a glass sheet or a stack of glass sheets, the process comprising the gravity bending of the glass on a skeleton comprising a contact rail supporting the glass in the peripheral zone of the lower main face thereof, said contact rail comprising concave curvatures in each of the sides of said skeleton, a counter-skeleton comprising a metal bar being present during the bending at a distance d from an edge face or from the peripheral zone of the upper main face of the glass, the peripheral zone of a main face being the zone between the edge of the glass and a distance from the edge of the glass of 50 mm of said main face, d being within the range from 0.1 to 50 mm.

2. The process as claimed in claim 1, wherein the process gives the glass concave shapes seen from above in its central zone and in each of its sides, the metal bar being at the distance d at least at the end of bending.

3. The process as claimed in claim 1, wherein the condition regarding the distance d is satisfied in at least one vertical plane perpendicular to the edge of the glass passing through the zone of the middle of at least one side of the glass, said zone of the middle being within the peripheral zone up to 20 cm on either side of the middle of the side.

4. The process as claimed in claim 3, wherein the condition regarding the distance d is satisfied in at least one vertical plane perpendicular to the edge of the glass passing through the zone of the middle of at least one side of the glass, said zone of the middle being within the peripheral zone up to 10 cm on either side of the middle of the side.

5. The process as claimed in claim 1, wherein the condition regarding the distance d is satisfied for any vertical plane passing through the zone of the middle of at least one side of the glass.

6. The process as claimed in claim 1, wherein the glass comprises four sides.

7. The process as claimed in claim 1, wherein d is within the range from 1 mm to 50 mm.

8. The process as claimed in claim 1, wherein the counter-skeleton touches neither the upper main face of the glass nor the edge face thereof at least at the end of bending.

9. The process as claimed in claim 1, wherein the counter-skeleton is covered with thermal insulation on at least one of the faces thereof opposite the glass.

10. The process as claimed in claim 1, wherein the counter-skeleton shields the glass from thermal radiation coming directly from heating elements.

11. The process as claimed in claim 1, wherein the counter-skeleton slows down the temperature rise of the periphery of the glass during the temperature rise phase in preparation for the bending.

12. The process as claimed in claim 1, wherein the glass is a stack of glass sheets.

13. The process as claimed in claim 1, wherein the glass is bent by gravity at a temperature within the range from 570 to 650° C.

14. The process as claimed in claim 1, wherein the counter-skeleton is colder than the periphery of the glass during the bending.

15. The process as claimed in claim 1, wherein the bending is carried out in a furnace, the counter-skeleton being at a temperature below 250° C. on entering the bending furnace.

16. The process as claimed in claim 1, wherein the skeleton and the counter-skeleton are conveyed together into a furnace, the glass being in contact with the skeleton for more than 10 minutes in the furnace.

17. The process as claimed in claim 1, wherein the counter-skeleton does not touch the glass when the glass comes into contact with the entire perimeter of the skeleton.

18. The process as claimed in claim 1, wherein when the glass comes into contact with the entire perimeter of the skeleton, the upper face of the glass is only in contact with the ambient air.

19. A device for the gravity bending of a glass sheet or a stack of glass sheets, the device comprising a skeleton comprising a contact rail for supporting the peripheral zone of the lower main face of the glass, said contact rail comprising concave curvatures in each of the sides of said skeleton, and a counter-skeleton comprising a metal bar, said counter-skeleton being configured so that its metal bar is present at a positive distance d from the peripheral zone of the upper main face of the glass or from the edge face thereof.

20. The device as claimed in claim 19, wherein the device is configured to give the glass concave shapes seen from above in its central zone and in each of its sides, the distance d being complied with at least at the end of bending.

21. The device as claimed in claim 19, wherein the condition regarding the distance d is satisfied in at least one vertical plane perpendicular to the edge of the glass passing through the zone of the middle of at least one side of the glass, said zone of the middle being within the peripheral zone up to 20 cm on either side of the middle of the side.

22. The device as claimed in claim 21, wherein the condition regarding the distance d is satisfied in at least one vertical plane perpendicular to the edge of the glass passing through the zone of the middle of at least one side of the glass, said zone of the middle being within the peripheral zone up to 10 cm on either side of the middle of the side.

23. The device as claimed in claim 19, wherein the condition regarding the distance d is satisfied for any vertical plane passing through the zone of the middle of at least one side of the glass.

24. The device as claimed in claim 19, wherein the glass comprises four sides.

25. The device as claimed in claim 19, wherein the distance d is within the range from 0.1 to 50 mm.

26. The device as claimed in claim 19, wherein the metal bar of the counter-skeleton is at least partially above the skeleton and/or opposite the outer face of the skeleton.

27. The device as claimed in claim 19, wherein the metal bar of the counter-skeleton is at least partially above the level of the centre of the contact rail for the glass of the skeleton.

28. The device as claimed in claim 19, wherein the skeleton comprises a metal strip, one edge face of which is oriented upward, said edge face being covered with a refractory fibrous material forming the contact rail for the glass.

29. The device as claimed in claim 19, wherein the counter-skeleton is removable.

30. The device as claimed in claim 29, wherein the counter-skeleton comprises laterally retractable strips.

31. The device as claimed in claim 19, further comprising a means for imposing the distance d comprising a stop attached to the skeleton and a counter-stop attached to the counter-skeleton, the counter-stop being able to rest on the stop.

32. The device as claimed in claim 19, further comprising a means for adjusting the distance d.

33. The device as claimed in claim 19, wherein the counter-skeleton is covered with thermal insulation on one of the faces thereof opposite the skeleton.

34. The device as claimed in claim 19, wherein the counter-skeleton comprises a tube able to receive a stream of a coolant.

35. The device as claimed in claim 19, further comprising a rigid structural element positioned above the metal bar of the counter-skeleton, the structural element and the metal bar being connected together by a plurality of spacers preferably that can be adjusted in terms of their length.

36. The device as claimed in claim 19, further comprising a furnace and a conveyor able to horizontally move the skeleton and the counter-skeleton together through the furnace and with no relative horizontal movement of one with respect to the other.

37. The device as claimed in claim 36, further comprising a plurality of skeleton/counter-skeleton assemblies each loaded with glass and circulating one behind the other through the furnace.
